(19) United States
(12) Patent Application Publication
(10) Pub. No.: US 2008/0083340 A1
(43) Pub. Date: Apr. 10, 2008

(54) Roaster

(75) Inventor: Delvin R. Ryan, Lake Zurich, IL (US)

Correspondence Address: SEYFARTH SHAW LLP, 131 S. DEARBORN ST., SUITE 2400, CHICAGO, IL, 60603-5803, US

(73) Assignee: Columbian Home Products, Terre Haute, IN (US)

(21) Appl. No.: 11/546,123

(22) Filed: Oct. 10, 2006

(51) Int. Cl. A47J 37/07

(52) U.S. Cl. 99/450

(57) ABSTRACT

A roaster including an open-top receptacle having a bottom wall and a peripheral side wall extending from a side of the bottom wall. The bottom wall defines a plurality of elongated parallel ribs projecting outwardly from the side of the bottom wall, where at least one of the ribs includes a plurality of spaced-apart sections.

### BACKGROUND

Several different types of containers are used to cook food. Some pans, such as sauce pans, are used to cook food on a stove. Other types of pans and containers are used to cook food in ovens. These pans or containers come in all different sizes to accommodate different sizes of foods. Containers used to cook foods in ovens are made of a durable material which can withstand the elevated temperatures in ovens. One container used to cook foods in ovens is a roaster. A roaster is a container or dish used to bake, roast or heat food in an oven. A food item, such as a whole chicken or turkey, is placed in the roaster and then set in the oven. Typically to prevent food from sticking to the bottom of the roaster and to lift food in and out of the roaster, a metal rack is placed on the bottom of the roaster underneath the food. The metal rack separates the bottom of the food from the roaster bottom and thereby prevents the food from sticking to the bottom of the roaster. Such metal racks are separate components which must be purchased separately from the roaster. A user must therefore purchase both the roaster and the rack which can be expensive.

Most roasters are relatively heavy because they are made of a durable material such as a heavy metal or coated metal. Furthermore, the weight of the food item being cooked in the roaster adds to the overall weight of the roaster, which makes inserting the roaster into or removing the roaster from an oven difficult and cumbersome.

Additionally, the inside surfaces of a roaster tends to be coated with grease or oil that comes from the food being cooked in the roaster. Typically, the grease and oil become cooked onto these surfaces, which makes cleaning the roaster difficult and time consuming.

Disposable aluminum roasters are available and eliminate the difficult cleaning process associated with the conventional metal roasters. The disposable roasters are very lightweight and provide easy cleanup. However, the aluminum roasters are flimsy and difficult to carry when food is in these roasters. Additionally, the disposable roasters are meant for one-time use and are discarded afterwards. Therefore, new disposable roasters must be purchased prior to each use. This can be expensive over time and burdensome to those persons who use roasters frequently.

Accordingly, there is a need for an improved roaster which overcomes the above problems.

### SUMMARY

One embodiment of a roaster of the present invention provides an open-top receptacle including a bottom wall and a peripheral side wall extending from a side of the bottom wall. The bottom wall defines a plurality of elongated parallel ribs projecting outwardly from the side of the bottom wall, where least one of the ribs includes a plurality of spaced-apart sections.

In an embodiment, the roaster includes a flange transverse to and extending outwardly from the peripheral side wall.

In an embodiment, the flange defines opposing gripping surfaces.

In an embodiment, the flange includes a first surface and second surface that oppose each other. The first surface includes at least one dimple and the second surface includes at least one depression.

In an embodiment, at least a portion of the side wall slopes outwardly from the bottom wall.

In an embodiment, a plurality of the ribs include a plurality of spaced-apart sections where the sections define at least two parallel channels.

In an embodiment, the receptacle is made of a metal at least partially coated by a porcelain material.

In an embodiment, the metal includes steel.

In an embodiment, the sections are different sizes.

Another embodiment provides a roaster including a generally planar bottom wall. The bottom wall defines a plurality of elongated parallel ribs projecting outwardly from a side of the bottom wall, where at least one of the ribs includes a plurality of spaced-apart sections. The roaster also includes a side wall extending outwardly from the side of the bottom wall, where the side wall includes a flange extending from the side wall. The flange forms at least two handles.

In an embodiment, one of the handles includes a dimple and the other of the handles includes a recess.

In an embodiment, a plurality of the ribs include a plurality of spaced-apart sections, where the sections define at least two parallel channels.

In an embodiment, the receptacle is made of a metal at least partially coated by a porcelain material.

In an embodiment, the metal includes steel.

In an embodiment, the sections include different lengths.

Other objects, features and advantages of the invention will be apparent from the following detailed disclosure, taken in conjunction with the accompanying sheets of drawings, wherein like numerals refer to like parts, elements, components, steps and processes.

### DESCRIPTION OF THE FIGURES

FIG. 1 is a perspective view of one embodiment of a roaster of the present invention.

FIG. 2 is a top view of the roaster of FIG. 1.

FIG. 3 is an end view of the roaster of FIG. 1.

FIG. 4 is a side view of the roaster of FIG. 1.

FIG. 5 is a cross-section view taken substantially along line 5-5 shown in FIG. 2.

### DETAILED DESCRIPTION

The present invention is directed generally to a roaster, and more specifically, to a reusable oval oven roaster which is nestable and which does not require a separate oven rack.

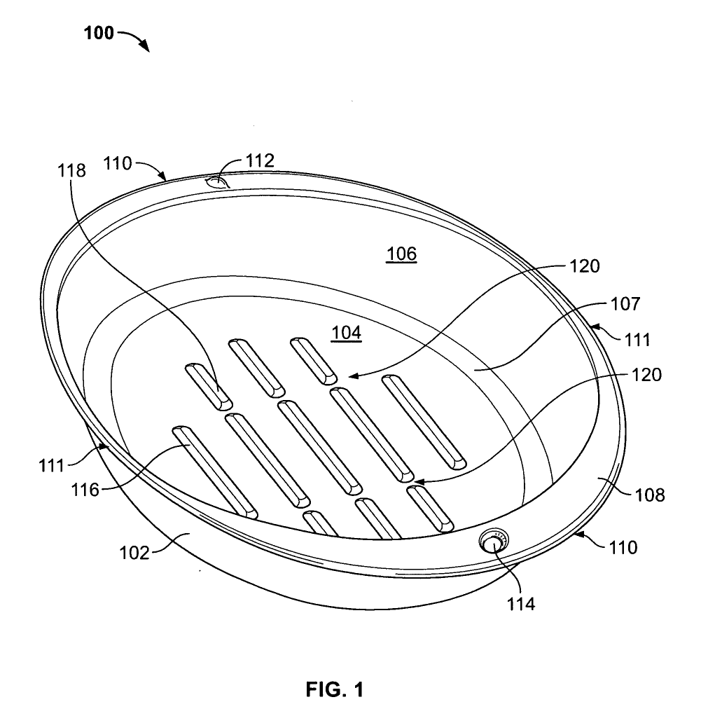

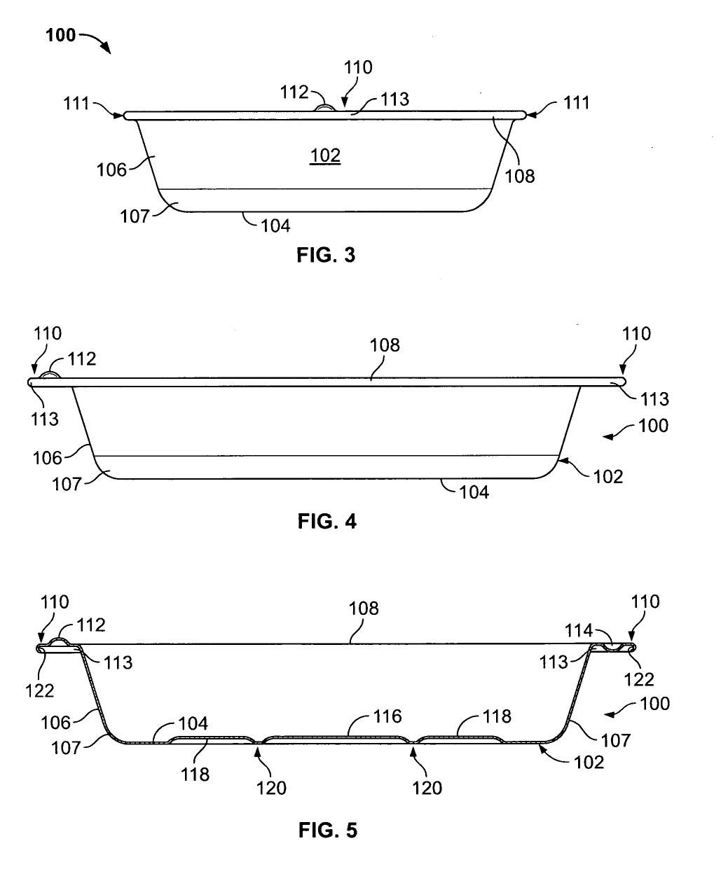

Referring to FIGS. 1-5, the roaster 100 includes an open-top receptacle or container 102 which has a generally oval shape. The receptacle 102 includes a bottom wall, bottom side or bottom surface 104 and a peripheral side wall 106 which extends from the bottom wall 104. Both the bottom wall 104 and the side wall 106 are oval shaped. It should be appreciated that the open-top receptacle 102 and more specifically the bottom wall 104 and the side wall 106 may be oval-shaped, square-shaped, rectangular-shaped or any suitable shape. It should also be appreciated that the open-top receptacle may be any suitable size to accommodate different sized foods or different amounts of food.

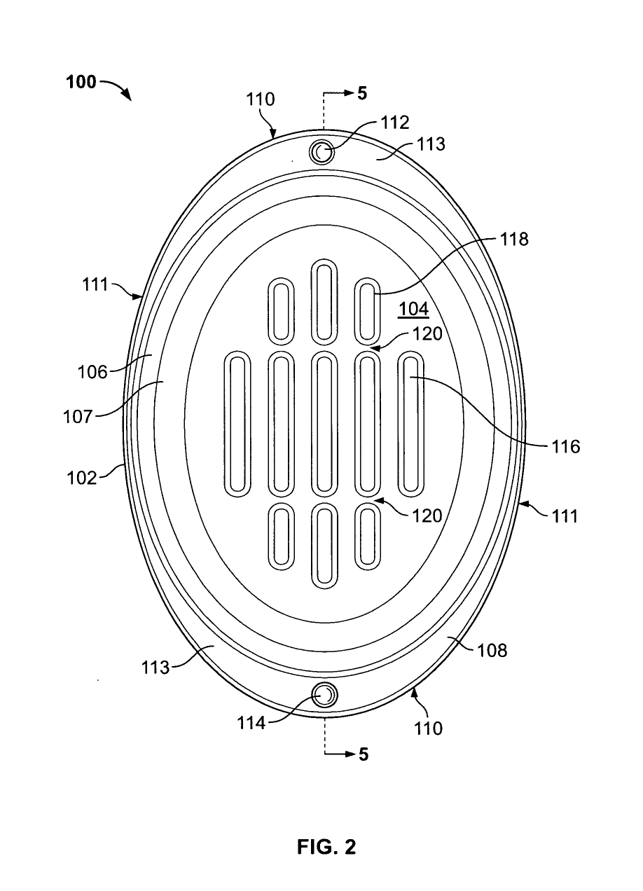

As shown in FIGS. 1 and 2, the peripheral side wall 106 extends outwardly from the bottom wall 104. In other words, the side wall 106 is sloped or angled away from the outer edge of the bottom wall 104. It should be appreciated that the side wall 106 may angle inwardly, outwardly or have any suitable configuration. The side wall 106 includes a beveled or rounded portion 107 which is integrally formed with the bottom wall 104. It should be appreciated that the bottom wall 104 and the side wall 106 may be integrally formed, connected together or joined or made in any suitable manner.

In the illustrated embodiment, a flange 108 is generally transverse to and extends outwardly from the side wall 106. As shown in FIG. 1, the flange 108 extends from the topmost or upper edge of the side wall. It should be appreciated that the flange 106 may extend from any suitable part or location of the side wall. In an embodiment, the flange 108 extends about the periphery of the side wall 106. The flange 108 includes opposing wider or larger portions 110 and opposing narrow or smaller portions 111, where the wider portions 110 extend outwardly from the side wall 106 a further distance at the opposing ends of the roaster. The wider portions 110 form gripping surfaces or handles 113 for a user. The handles 113 are integrally formed with the receptacle 102 to enable a user to easily grip and lift and/or move the roaster to and from an oven or to and from another surface or area.

Each of the gripping surfaces or handles 113 include a dimple 112 or a recess 114. In the illustrated embodiment, both the dimple 112 and the recess 114 have generally circular shapes. It should be appreciated that the dimple and/or the recess may any suitable size or shape. The dimple 112 extends or protrudes upwardly from a surface of the flange 108 and therefore has a convex surface as shown in FIG. 5.

The recess 114 is similar to the dimple 112 except that it extends or protrudes downwardly underneath surface of the flange 108 and has a concave surface. As shown in FIG. 5, the roaster 100 includes a dimple 112 on one of the handles 110 and a recess 114 at the opposing handle. The opposing dimple and recess enhance the nesting of one roaster into another roaster. For example, when a first roaster is nested in a second roaster, the dimple 112 on the first roaster is aligned and is seated on the dimple 112 of the second roaster, which is positioned adjacent to it. Similarly, the recess 114 on the first roaster is seated on the recess 114 of the adjacent second roaster. Engagement between the corresponding dimples and recesses helps to temporarily secure the roasters together and minimize the roaster from sliding with respect to each other when they are stacked or nested within each other and stored.

The dimple 112 and recess 114 also are used to secure a roaster in position on top of another roaster when a first roaster is used as a lid or cover for another roaster. In this situation, the roaster being used as the lid or cover is flipped over so that the inside surfaces of the bottom walls of the roasters are facing each other. The top roaster or lid is then positioned so that the dimple 112 of the roaster acting as the lid becomes seated in the recess 114 of the bottom roaster. Similarly, the recess 114 of the top roaster or lid contacts or is seated onto the corresponding dimple on the bottom roaster. Using a second roaster as a cover enables a user to cook foods in different ways and also enables the roaster combination to be tipped at angles up to 30° to 40° for removing or draining excess water, oils, greases, or other substances.

Referring to FIGS. 1, 2 and 5, a plurality of elongated ribs 116 and 118 are formed on the bottom wall 104. In an embodiment, the ribs 116 and 118 are integrally formed with the bottom wall 104 and extend upwardly from the same side or surface of the bottom wall from which the side wall 106 extends. As shown in FIG. 2, the ribs or protrusions 116 and 118 have different sizes and shapes. In the illustrated embodiment, each of the ribs 116 and 118 is a generally elongated, oval-shaped protrusion. In an embodiment, a plurality of ribs 116 and 118 are formed in the bottom wall 104 where at least one of the ribs 116 is longer than at least one of the ribs 118. In another embodiment, a plurality of the ribs 116 are longer than a plurality of the ribs 118. In a further embodiment, all of the ribs 116 are longer than the ribs 118.

In the illustrated embodiment, a plurality of the longer ribs 116 are positioned in the middle or center of the bottom wall 104. It should be appreciated that one, a plurality or all of the elongated ribs 116 may be positioned in the middle or on any suitable location on the bottom wall 104. At least one and preferably a plurality of the small ribs 118 are positioned at opposing ends of the longer ribs 116, as shown in FIG. 2. The ribs 116 and 118 are spaced apart or have interruptions that form channels or pathways 120. The channels or pathways 120 enable a cooking string to be positioned and maintained in place in the channels so that when cooking is done a food item, such as a chicken or turkey, can be easily lifted out of the roaster using the string. It should be appreciated that the ribs 116 and 118 may have any suitable size or shape.

Because the ribs 116 and 118 are integrally formed with the bottom 104, there is no need for a separate wire rack or oven rack to be placed in the roaster. The ribs also eliminate the cumbersome process of positioning or adjusting the position of an oven rack such as in conventional roasters. A user simply sets a food item, such a chicken or turkey on the ribs 116 and 118 and then puts the roaster 100 in an oven, on a grill or the like.

The ribs 116 and 118 minimize the frictional engagement between nested roasters to aid in separating the nested roasters. Specifically, the bottom surface of the bottom wall 104 of one roaster sits on top of the raised or protruding ribs 116 and 118 of an adjacent nested roaster. The ribs 116 and 118 therefore help to prevent one roaster from frictionally engaging an adjacent roaster so that it is less difficult to separate the roasters. Additionally, the flanges 108 of corresponding nested roasters also helps to prevent the roasters from frictionally engaging each other as the flange of one roaster sits on the flange of an adjacent nested roaster.

The roaster 100 can be used to cook or bake a variety of foods. One advantage of the roaster 100 is that the integrally formed ribs on the bottom surface of the roaster eliminates the need for a separate wire rack or oven rack to be placed in the roaster and also provides stable surfaces for the food item to rest on. The raised or protruding ribs 116 and 118 also raise the food item, such as a chicken or turkey, above the bottom wall 104 so that there is less contact between the juices, greases or oils that drain from the food item and collect in the bottom and sides of the roaster.

In the above embodiments, the open-top receptacle 102 is made of a suitable metal, such as stainless steel, and is coated by porcelain. It should be appreciated that the open-top receptacle 102 may be made of any suitable material or materials. It should also be appreciated that the open-top receptacle may be coated by any suitable material or combination of materials. The porcelain coating on the underlying metal surface provides a non-skid, non-stick surface which is smooth and relatively easy to clean.

While the present invention is described in connection with what is presently considered to be the most practical and preferred embodiments, it should be appreciated that the invention is not limited to the disclosed embodiments, and is intended to cover various modifications and equivalent arrangements included within the spirit and scope of the claims. Modifications and variations in the present invention may be made without departing from the novel aspects of the invention as defined in the claims, and this application is limited only by the scope of the claims.

The invention is claimed as follows:

1. A roaster comprising:
an open-top receptacle including a bottom wall and a peripheral side wall extending from a side of said bottom wall, the bottom wall defining a plurality of elongated parallel ribs projecting outwardly from said side of said bottom wall, at least one of said ribs including a plurality of spaced-apart sections.

2. The roaster of claim 1, which includes a flange transverse to and extending outwardly from said peripheral side wall.

3. The roaster of claim 2, wherein said flange defines opposing gripping surfaces.

4. The roaster of claim 2, wherein said flange includes a first surface and second surface, said first and second surfaces opposing each other, said first surface including at least one dimple and said second surface including at least one depression.

5. The roaster of claim 1, wherein at least a portion of said side wall slopes outwardly from said bottom wall.

6. The roaster of claim 1, wherein a plurality of said ribs include a plurality of spaced-apart sections, said sections defining at least two parallel channels.

7. The roaster of claim 1, wherein said receptacle is made of a metal at least partially coated by a porcelain material.

8. The roaster of claim 1, wherein the metal includes steel.

9. The roaster of claim 1, wherein said sections are different sizes.

10. A roaster comprising:
a generally planar bottom wall, the bottom wall defining a plurality of elongated parallel ribs projecting outwardly from a side of said bottom wall, at least one of said ribs including a plurality of spaced-apart sections; and
a side wall extending outwardly from said side of said bottom wall, said side wall including a flange extending from said side wall, said flange forming at least two handles.

11. The roaster of claim 10, wherein one of said handles includes a dimple and said other of said handles includes a recess.

12. The roaster of claim 10, wherein a plurality of said ribs include a plurality of spaced-apart sections, said sections defining at least two parallel channels.

13. The roaster of claim 10, wherein said receptacle is made of a metal at least partially coated by a porcelain material.

14. The roaster of claim 13, wherein the metal includes steel.

15. The roaster of claim 10, wherein said sections include different lengths.
